(19) United States
(12) Patent Application Publication
(10) Pub. No.: US 2009/0200699 A1
(43) Pub. Date: Aug. 13, 2009

(54) SPORTS BOARD

(76) Inventor: Scott Burke, Oceanside, CA (US)

Correspondence Address: STEVEN VOSEN, 1563 SOLANO AVENUE #206, BERKELEY, CA, 94707, US

(21) Appl. No.: 12/194,396

(22) Filed: Aug. 19, 2008

Related U.S. Application Data
(60) Provisional application No. 60/968,530, filed on Aug. 28, 2007.

(51) Int. Cl. B29C 59/02; B29C 65/02

(52) U.S. Cl. 264/241

(57) ABSTRACT

Methods of incorporating certain features into sports boards by compression molding are described. The boards may include a foam core and have top and bottom layers, and the board may be flat or have curved surfaces. The incorporated features may include, but are not limited to, tracking rails or graphic designs. The resulting sports boards are easier to produce, are less expensive, and have more consistent quality of manufacturing than existing boards.

### CROSS-REFERENCE TO RELATED APPLICATIONS

This application claims the benefit of U.S. Provisional Application No. 60/968,530, filed Aug. 28, 2007, the entire contents of which is hereby incorporated by reference herein and made part of this specification.

### BACKGROUND OF THE INVENTION

1. Field of the Invention

The present invention generally relates to sports boards, and more particularly to providing structure and/or graphics to sports boards.

2. Discussion of the Background

A conventional sports board, such as a slider, a bodyboard and the like, typically includes a foam core, a top layer, a bottom layer. In many boards, the foam core is made of expanded polyethylene foam material, and the top and bottom layers are formed separately and then laminated to the core. The top layer typically includes a polyethylene film and/or a polyethylene foam sheet. The bottom layer is similar to, though usually thicker than, the top layer so as to improve its wear-resistance when the sports board is in use. Such boards are generally flat or slightly curved. Additional structures, such as rails or grips are separately formed and affixed to the board.

Additionally, colored graphics or patterns are imprinted on the top layer and the bottom layer of the sports board so as to improve the value and appearance of the sports board. However, the imprinted graphics are easily to fade and wear off due to the ultraviolet and frequently use outdoor. Therefore, the sports boards/sleds have enduring patterns and structures are in great demand.

The limitations of prior art sports boards make the incorporation of additional structures and certain graphic elements difficult and relatively expensive. In addition, quality control of prior art boards is difficult. There is a need in the art for sports boards having improved ability to add structures to the board. There is also a need in the art for sports boards having improved ability to add graphic elements to the board. Further, there is a need for a method of producing boards that is less expensive and that has more consistent quality of manufacturing.

### BRIEF SUMMARY OF THE INVENTION

The present invention overcomes the disadvantages of prior art by allowing for the incorporation of certain features into the board by forming the board using compression molding. Thus, for example, tracking rails may be molded into the bottom surface by compression molding polymer layers, such as a polyethylene top layer onto an expanded polystyrene core. Also, for example, a curved upper surface may be molded into the top surface by compression molding a top polyethylene layer onto an expanded polystyrene core. Also, the process of compression molding permits the incorporation of additional graphic designs into either the top or bottom surfaces of the board.

In certain embodiments, tracking rails are incorporated into the board, enhancing the performance of the boards, such as allowing for improved tracking and speed.

In certain other embodiments, boards include combinations of hard and soft foam that provide for added stiffness, the incorporation of three-dimensional graphic designs, and harder edges for better control and a smoother ride.

In certain embodiments, a method of producing a sports board having from two or more layers is provided. The sports board includes two or more layers, including a top layer and a bottom layer. The method includes compression molding the top layer and the bottom layer.

In certain other embodiments, a method of producing a sports board is provided. The method includes compression molding tracking rails into the layers of the sports board.

In certain embodiments, a method of producing a sports board having from two or more layers is provided. The two or more layers include a top layer and a bottom layer. The method includes compression molding the sports board with a generally concave top surface and a generally convex bottom surfaces.

These features together with the various ancillary provisions and features which will become apparent to those skilled in the art from the following detailed description, are attained by the sports board of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a top view plan view of one embodiment of a sports board;

FIG. 2 is a side elevational view of the sports board embodiment of FIG. 1;

FIG. 3 is a bottom plan view of the sports board embodiment of FIG. 1;

FIG. 4A is a cross-sectional view 4-4 of a first embodiment of a sports board;

FIG. 4B is a cross-sectional view 4-4 of a second embodiment of a sports board;

FIG. 5 is a schematic of the filling a core mold;

FIG. 6 is a schematic of the heating of a core mold material;

FIG. 7 is a schematic of the cooling and releasing of the core;

FIGS. 8-13 are schematics showing the method of forming a sports board having a top layer, a core, and a bottom layer, where FIG. 8 is a schematic of the placement of the core, the bottom material, and an adhesive into a mold; FIG. 9 is a schematic of the bonding of the bottom material to the core; FIG. 10 is a schematic showing the release of the bottom material and core from the mold; FIG. 11 is a schematic of the placement of the bonded core and bottom material, the top material, and an adhesive into a mold; FIG. 12 is a schematic of the bonding of the top material to the core and bottom material; and FIG. 13 is a schematic showing the release of the board from the mold; FIG. 8 is a schematic of the placement of the core, the bottom material, and an adhesive into a mold; and

FIGS. 14-16 are schematics showing a method of forming a sports boards having a top and bottom layer, where FIG. 14 is a schematic of the top and bottom layers placed in a mold; FIG. 15 is a schematic showing the compression molding of the top and bottom layers; and FIG. 16 shows the release of the board from the mold.

Reference symbols are used in the Figures to indicate certain components, aspects or features shown therein, with reference symbols common to more than one Figure indicating like components, aspects or features shown therein.

### DETAILED DESCRIPTION OF THE INVENTION

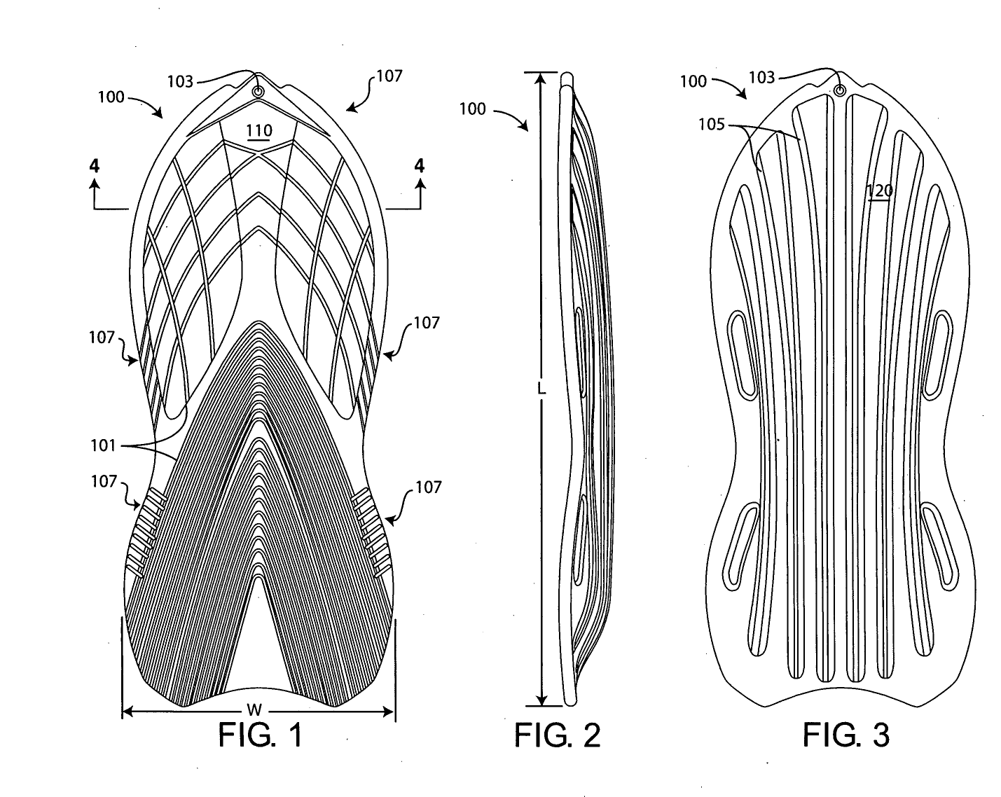

One embodiment of a sports board is shown in FIGS. 1, 2, and 3, where FIG. 1 is a top view plan view, FIG. 2 is a side elevational view, and FIG. 3 is a bottom plan view of sports board 100. Sports board 100 may be, for example and without limitation, a snow board, a snow sled, a body board, a surf board, a skim board, a wake board, or similar recreational board for sliding along snow or water. Sports board 100 has a top surface 110 and a bottom surface 120. Sports board 100 has a hole 103 for storing the board on a peg or for passing a rope. Bottom surface 120 includes tracking rails 105.

In an alternative embodiment, handles are located at or near one or more positions 107. Handles may be secured to sports board 100, for example and without limitation, as described in U.S. Pat. No. 7,083,173, the contents of which are incorporated herein by reference.

Either one or both of top surface 110 and bottom surface 120 may include a design 101 that includes, but is not limited to, having a combination of one or more of a sold, portion, a printed pattern, a silk-screened pattern, or may include a printed graphic on film or a non-woven material. Alternatively, there may be no designs on either top surface 110 or bottom surface 120.

Sports board 100 may be used, for example and without limitation, as a snow board. In one embodiment, sports board 100 has a length L and a width W large enough to permit a person to sit or lay on the board. Thus, for example, the length L of may range from 2 feet to 10 feet, and the width W may range from 6 inches to 36 Inches. Children, for example, may sit on or lie prone on top surface 110. Tracking rails 105 may be configured to aid in steering board 110 while sledding. Thus, for example, children may steer board 100 while sliding down hill on snow by shifting their weight from side to side causing tracking rails 105 to dig into the snow and carve a turn. In one embodiment, tracking rails 105 have: 1) a length of from 2 feet to 10 feet that is generally along the length L of sports board 100, 2) a width of from 0.125 inches to 3 inches that is generally along the width W of the sports board; and 3) a height of from 0.125 inches to 1 inches that protrudes way from the sports board.

It should be understood that design 101, tracking rails 105, and the number and location of handles, if present, are not limited to those illustrated in on sports board 100. Further, it should be understood that in some applications, such as a board for use on water, tracking rails 105 may take the form of fins configured to aid in steering the board gliding through water, and the position and size of the tracking rails may differ according to activities for which the board is designed.

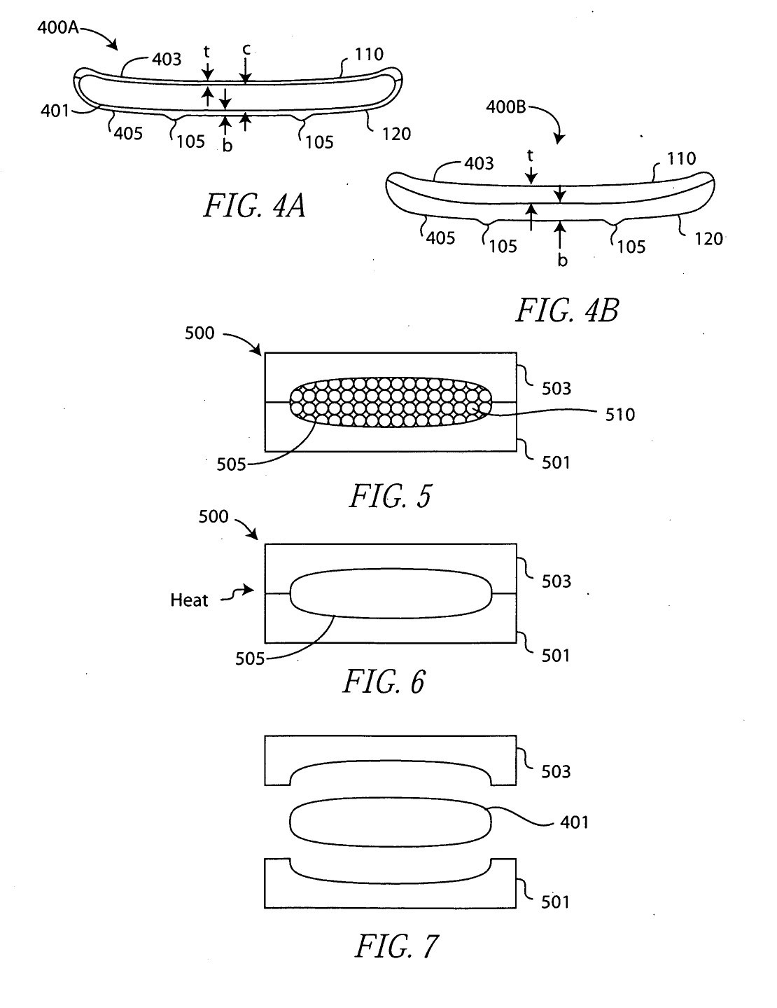

FIG. 4A is a cross-sectional view 4-4 of a first embodiment of sports board 400A, showing a core 401, having a thickness c, a top material 403 having a thickness t and bonded to on one side of the core, and a bottom material 405 having a thickness b and bonded to opposing side of the core. Top material 403 is also referred to herein without limitation as a “deck” or “deck layer,” which forms top surface 110 and supports design 101. Bottom material 405 is also referred to herein without limitation as a “bottom layer.” and forms bottom surface 120 and supports tracking rails 105. The thicknesses b, c, and t may be uniform throughout board 400A, or may vary along the board.

FIG. 4B is a cross-sectional view 4-4 of a second embodiment of sports board 400B, which differs from board 400A in that the board includes top material 403 bonded to bottom material 405 without an interposed core.

In one embodiment, core 401 is a foam having an unexpanded density of from 2 pounds per cubic foot (pcf) to 10 pcf. In another embodiment, core 401 is an expanded polystyrene (EPS). In yet another embodiment, core 401 is an expanded polypropylene. In another embodiment, one or more of top material 403 and bottom material 405 is a layer of a PE, including but not limited to a low density PE (LDPE) or a high density PE (HDPE), or PP material, including but not limited to, or a high density PP (HDPP). Alternatively, one or more of top material 403 and bottom material 405 is a cross-linked or a non-cross linked polyethylene (PE) foam, or an irradiated or chemically cross-linked polypropylene (PP) foam. Alternatively, one or more of top material 403 and bottom material 405 may be include graphics or decoration applied by a printing, sublimation, hot stamp, or silk screen process, or may include a printed graphic on film or a non-woven material that is adhesively bonded or co-extruded on top 110 and/or bottom 120.

The thicknesses c, b, and t are selected to provide support for a rider of sports board 400A and may be rigid or flexible. In one embodiment, thickness C is from ½ inch to 5 inches, the thickness t is from 1/16 inch to ¼ inch, and the thickness b is from 0.005 inch to 0.050 inch.

One method of manufacturing board 400A is illustrated in FIGS. 5 through 13. First, an expanded polystyrene core 401 is produced, as shown in FIGS. 5, 6, and 7, where FIG. 5 is a schematic of the filling a core mold, FIG. 6 is a schematic of the heating of a core mold material, and FIG. 7 is a schematic of the cooling and releasing of the core.

As shown schematically in FIGS. 5-7, a mold 500 includes two or more parts that, when brought together, have an interior volume 505 in which expanded polystyrene core 401 is formed. Mold 500 is placed within a mold press to compression mold material placed therein. In one embodiment, mold 500 includes a first part 501 and second part 503. A first step is the filling of mold 500 with polystyrene beads 510, as shown schematically in FIG. 5. It is preferred that final density of the expanded polystyrene core 401 is from 0.75 to 2.5 pcf.

In one embodiment, the filling includes: i) preliminary filling, where compressed air is supplied to the mold; ii) supplying core material, where the polystyrene beads are supplied into the mold; and iii) recovery, where excess polystyrene beads are recovered to the hopper.

A next step is heating beads 510, as shown schematically in FIG. 6. The heating causes the polystyrene to become foamed and thermally fused in the shape of the mold.

In one embodiment, the heating includes: i) pre-heating (exhaustion), where steam is supplied to remove air between the beads; ii) unilateral heating, where steam is flowed into the mold in diagonal direction to fuse beads inside the product; iii) bilateral heating, where steam is supplied from both sides of the mold with the closed drains to fuse the sections near the surface; and iv) auxiliary heating (reversed unilateral heating), where steam is supplied in the reverse direction of the unilateral heating.

After heating, the polystyrene in beads 510 have foamed and expanded to fill volume 505, which is the shape of core 401. The next steps include cooling and removing core 401 from mold 500, as shown schematically in FIG. 6. In one embodiment, cooling includes the step of water-cooling, where water cools the mold and the polystyrene. In one embodiment, the temperature of the cooling water is maintained consistently (60° C.) to prevent shrinkage. Alternatively, cooling includes natural cooling (or vacuum cooling), where sprayed water is eliminated and the core is cooled.

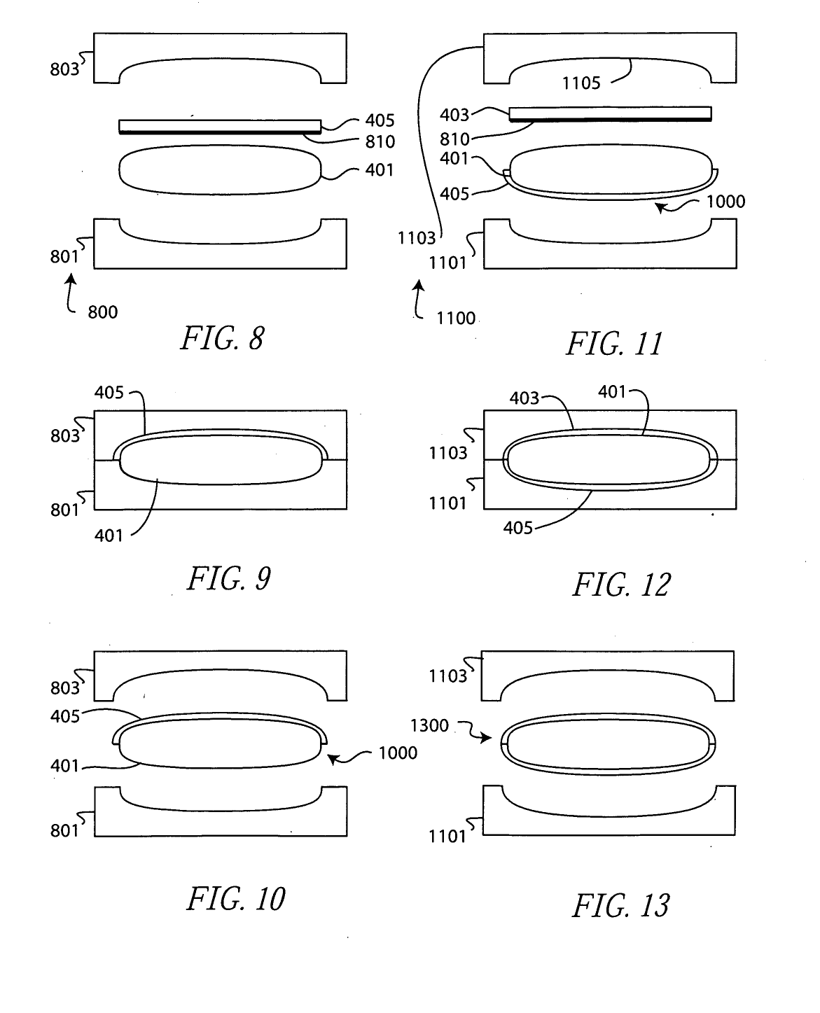

FIGS. 8-13 are schematics showing one method of forming a sports board 400A having a top layer, a core, and a bottom layer. FIGS. 8, 9, and 10 illustrate the bonding of bottom material 405 to core 401, where FIG. 8 is a schematic of the placement of the core and the bottom, into a mold 800; FIG. 9 is a schematic of the bonding of the bottom material to the core, and FIG. 10 is a schematic showing the release of the bonded bottom material and core from the mold.

First, an adhesive layer 810 is applied bottom material 405. In one embodiment, adhesive layer 810 is extruded on to bottom material 405. In another embodiment, adhesive layer 810 is a ethylene-vinyl acetate (EVA) resin or a PE/EPS combination resin. Bottom material 405 is then heated to facilitate bonding to core 401. Appropriate temperatures depend on the adhesive and may be for example a temperature of from 175° F. to 200° F.

Next, as illustrated in FIG. 8, core 401 and heated bottom material 405 with adhesive 810 are placed between a first part 801 and a second part 803 of mold 800. Mold 800 is placed within a compression mold to compression mold material placed therein. The core 401 and bottom material 405 are then compressed, as shown schematically in FIG. 9, to bond the core and bottom material. As shown in FIG. 10, mold 800 is opened, and bonded core 401 and bottom material 405, indicated as piece 1000, is removed from the mold. Next, excess bottom material 405 is trimmed from the bonded core 401 and bottom material.

One method of manufacturing board 400A is further shown in FIGS. 11, 12, and 13, as the bonding of top material 403 to bonded core 401 and bottom material 405, where FIG. 11 is a schematic of the placement of the top material and bonded core and bottom material into a mold 800; FIG. 12 is a schematic of the bonding of the top material to the bonded core and bottom material, and FIG. 13 is a schematic showing the release of the board from the mold. In various alternative embodiments, top material 403 and/or bottom material 405 is perforated with a sufficient number of holes to permit air to escape during the molding process, enabling the material to better conform to features in the mold. The perforation may be accomplished, for example and without limitation, by forcing a number of pins or nails through the material.

First, an adhesive layer 810 is applied to top material 403, and the top material is heated to facilitate bonding to core 401. In one embodiment, adhesive layer 810 is extruded onto top material 403. Top material 403 is heated to a temperature of 175° F. to 200° F.

Next, as illustrated in FIG. 11, core 401 and heated top material 403 are placed between a first part 1101 and a second part 1103 of mold 1100. In one embodiment, second part 1103 includes a pattern on surface 1105, which may be an emboss pattern, and deboss pattern, or some combination thereof, and which corresponds, for example, to pattern 101 of sports board 100. The core 401, top material 403, and bottom material 405 are then compressed, as shown schematically in FIG. 12, to bond the top material to the bonded core and bottom material.

As shown in FIG. 13, mold 1100 is opened, and bonded core 401 and top material 403 is removed from the mold, indicted by piece 1300. Next, excess top material 403 is trimmed from the bonded core 401 and top material is trimmed and healed up to the edge of bottom material and sealed with a combination of heat and water in order to close the finished trims cells. The resulting board 400A includes pattern 101 as transferred from the pattern on surface 1105.

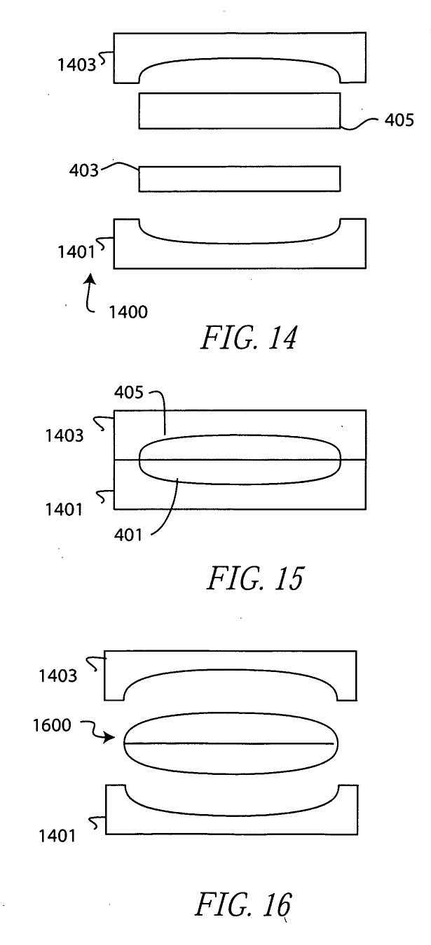

FIGS. 14-16 are schematics showing a method of forming a sports boards, such as a board 400B having a top and bottom layer. where FIG. 14 is a schematic of the top and bottom layers placed in a mold; FIG. 15 is a schematic showing the compression molding of the top and bottom layers; and FIG. 16 shows the release of the board from the mold. The method of FIGS. 14-16 is generally similar to the method of FIGS. 8-13, except as noted subsequently.

First, one or more of top material 403 and bottom material 405 are heated to facilitate bonding. As an example for the top and bottom materials 403 and 405 may be heated to a temperature of from 150° F. to 350° F. As shown in FIG. 14, top material 403 and bottom material 405 are then placed in mold 1400, more specifically between mold forms 1401 and 1403. Next, as shown in FIG. 15, materials 403 and 405 are compressed between mold forms 1401 and 1404. In one embodiment, a pattern on the mold is transferred from one or both of forms 1401 and 1403, as an embossed and/or debossed pattern, as described above. Top material 403 and bottom material 405 are formed into a piece 1600, Next, excess bottom material 405 is trimmed from the bonded core 401 and bottom material and the top material and bottom material is sealed with a combination of heat and water in order to close the finished trims cells to form a board 400B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention.

I claim:

1. A method of producing a sports board having from two or more layers, where one of said two or more layers is a top layer and one of said two or more layers is a bottom layer, said method comprising:
compression molding the top layer and the bottom layer of the sports board.

2. The method of claim 1, where said compression molding includes forming tracking rails in said bottom layer.

3. The method of claim 2, where said tracking rails have a height of from 0.125 inches to 1 inch.

4. The method of claim 1, where said compression molding includes forming an embossed or debossed pattern on said top layer.

5. The method of claim 1, where said compression molding includes forming a concave top layer.

6. The method of claim 1, where said top layer or said bottom layer includes a cross-linked polyethylene (PE) foam, a non-cross linked PE foam, or an irradiated or chemically cross-linked polypropylene (PP) foam.

7. The method of claim 1, where said top layer or said bottom layer has a thickness of from 0.005 inches to 0.25 inches.

8. The method of claim 1, where said top layer or said bottom layer is a layer of polyethylene.

9. The method of claim 1, where said sports board has three or more layers, where one of said three layers is a core layer, said compression molding including compression molding the top layer and the bottom layer on opposing sides of said core layer.

10. The method of claim 1, further comprising perforating said top layer or said bottom layer before said compression molding.

11. The method of claim 9, where said core layer includes expanded polystyrene, a polyethylene foam, or a cross-linked polypropylene foam.

12. The method of claim 9, where said core has a thickness of from ½ inch to 5 inches.

13. The method of claim 9, where said core is a foam having an unexpanded density of foam from 2 pounds per cubic foot to 10 pounds per cubic foot.

14. A method of producing a sports board having from two or more layers, where one of said two or more layers is a top layer and one of said two or more layers is a bottom layer, said method comprising:
compression molding the sports board with a generally concave top surface and a generally convex bottom surface.

15. The method of claim 14, where said compression molding includes forming tracking rails in said bottom layer.

16. The method of claim 15, where said tracking rails have a height of 0.125 inches to 1 inch.

17. The method of claim 14, where said compression molding includes forming an embossed or debossed pattern on said top layer.

18. The method of claim 14, where the sports board has from two or more layers, where one of said two or more layers is a top layer and one of said two or more layers is a bottom layer, where said compression molding includes:
compression molding the top layer and the bottom layer of the sports board.

19. The method of claim 14, further comprising perforating said top layer or said bottom layer before said compression molding.

20. The method of claim 18, where said top layer or said bottom layer includes a cross-linked polyethylene (PE) foam, a non-cross linked PE foam, or an irradiated or chemically cross-linked polypropylene (PP) foam.

21. The method of claim 18, where said top layer or said bottom layer has a thickness of from 0.005 inches to 0.25 inches.

22. The method of claim 18, where said top layer or said bottom layer is a layer of polyethylene.

23. The method of claim 18, where said sports board has three or more layers, where one of said three layers is a core layer, said compression molding including compression molding the top layer and the bottom layer on opposing sides of said core layer.

24. The method of claim 23, where said core layer includes expanded polystyrene, a polyethylene foam, or a cross-linked polypropylene foam.

25. The method of claim 23, where said core has a thickness of from ½ inch to 5 inches.

26. The method of claim 23, where said core has a foam having an unexpanded density of from 2 pounds per cubic foot to 10 pounds per cubic foot.
